(19) United States
(12) Patent Application Publication
(10) Pub. No.: US 2026/0055284 A1
(43) Pub. Date: Feb. 26, 2026

(54) INK, INKJET RECORDING METHOD, AND INKJET RECORDING SYSTEM

(71) Applicant: Konica Minolta, Inc., Tokyo (JP)

(72) Inventors: Yoshihito TAGUCHI, Kawasaki-shi (JP); Kouji IZAWA, Utsunomiya-shi (JP); Masashi IKEDA, Tokyo (JP); Chikage OMOTE, Tokyo (JP)

(21) Appl. No.: 19/303,018

(22) Filed: Aug. 18, 2025

(30) Foreign Application Priority Data
Aug. 20, 2024 (JP) 2024-139139

(51) Int. Cl. C09D 11/101; B41J 11/00; B41M 7/00

(52) U.S. Cl. CPC C09D 11/101; B41J 11/00214; B41M 7/0081

(57) ABSTRACT

An ink includes a polymerizable compound that is polymerized by an active ray and a gelling agent. A content of polyfunctional (meth)acrylate having a glycerol skeleton is 20 parts by mass or more to 100 parts by mass of the polymerizable compound. The content of, as the polyfunctional (meth)acrylate, trifunctional (meth) acrylate having a glycerol skeleton may be 20 parts by mass or more to 100 parts by mass of the polymerizable compound.

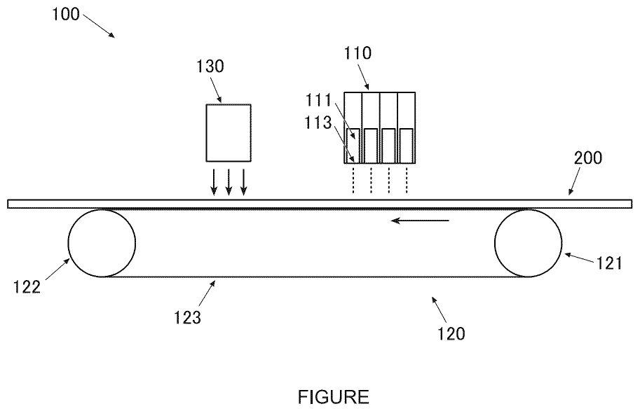

### CROSS-REFERENCE TO RELATED APPLICATIONS

The entire disclosure of Japanese Patent Application No. 2024-139139, filed on Aug. 20, 2024, including description, claims, drawings and abstract is incorporated herein by reference.

### BACKGROUND OF THE INVENTION

### Technical Field

The present disclosure relates to an ink, an inkjet recording method, and an inkjet recording system.

### Description of Related Art

Active ray curable ink is known as ink used in various printing fields. The active ray curable ink contains, as a liquid component, a compound (polymerizable compound) that is polymerized by active rays. The active ray curable ink can be cured by irradiation with active rays, and can make a coloring agent firmly adhere to recording medium (Japanese Unexamined Patent Publication No. 2021-195468, Japanese Unexamined Patent Publication No. 2017-088863 and International Publication No. 2016/096603).

### SUMMARY OF THE INVENTION

In recent years, the use of recorded matters formed using active ray curable ink has spread, and processing such as folding and cutting may be further performed after formation of the recorded matters. However, it has been found that the ink described in Japanese Unexamined Patent Publication No. 2021-195468, Japanese Unexamined Patent Publication No. 2017-088863 and International Publication No. 2016/096603 is not sufficiently suitable for these types of processing, and cracking is likely to occur by bending, and peeling is likely to occur by cutting.

An object of the present disclosure is to provide an ink or the like that reduces cracking by folding and peeling by cutting during processing of a recorded matter to be formed.

In order to achieve the object, the present inventors have studied the causes and the like of the above problems. As a result, the following were found, leading to the present disclosure.

That is, the aforementioned object of the present disclosure is achieved by the following means.

To achieve at least one of the abovementioned objects, according to an aspect of the present disclosure, an ink reflecting one aspect of the present disclosure includes:
a polymerizable compound that is polymerized by an active ray; and
a gelling agent,
wherein a content of polyfunctional (meth)acrylate having a glycerol skeleton is 20 parts by mass or more to 100 parts by mass of the polymerizable compound.

### BRIEF DESCRIPTION OF THE DRAWINGS

The advantages and features provided by one or more embodiments of the present disclosure will become more fully understood from the detailed description given hereinafter and the appended drawings which are given by way of illustration only, and thus are not intended as a definition of the limits of the present disclosure, and wherein:

FIGURE is a schematic diagram illustrating a configuration of an inkjet recording apparatus.

### DETAILED DESCRIPTION

Although the realization mechanism or action mechanism of the effects of the present disclosure is not clear, the present inventor(s) infers the mechanism as follows.

In general, the larger the number of polymerizable functional groups per molecule of a polymerizable compound, the higher the hardness of an obtained polymer. Furthermore, if the polymerizable compound has a branched structure, the hardness of an obtained polymer is high. Therefore, in the polymerizable compound, the hardness of an obtained polymer can be adjusted by adjusting the number of polymerizable functional groups, the branched structure, and the like.

The ink according to the present disclosure contains a polyfunctional (meth)acrylate having a glycerol skeleton as a polymerizable compound. That is, the compound has a branched structure in a molecule, and the number of (meth)acryloyl groups is three or more. Thus, a polymer obtained by polymerizing the compound has flexibility while having moderate hardness. Therefore, it is considered that the formed recorded matter is less likely to be broken even when folded.

The ink of the present disclosure contains a gelling agent. An ink containing a gelling agent has a low viscosity at high temperatures and a high viscosity at low temperatures. Therefore, the ink easily wets the recording medium at the time of landing, and there is an effect of suppressing cracking of the ink layer in the recorded matter to be formed. Furthermore, as described above, the polymer obtained by polymerizing the compound has an appropriate hardness. As a result, it is considered that even when the recorded matter is cut, the ink layer and the recording medium are sufficiently adhered to each other, and the ink layer is hard, so that the ink layer is unlikely to be peeled off even when the cut spot is rubbed.

The ink of the present disclosure is an ink containing a polymerizable compound that is polymerized by active rays. In the ink according to the present disclosure, the content of the polyfunctional (meth)acrylate having a glycerol skeleton is 20 parts by mass or more relative to 100 parts by mass of the polymerizable compound, and the ink contains a gelling agent.

The above features are technical features common to or corresponding to the following embodiments.

In an embodiment of the present disclosure, it is preferable that the content of trifunctional (meth)acrylate having a glycerol skeleton is 20 parts by mass or more relative to 100 parts by mass of the polymerizable compound, from the viewpoint of being able to reduce cracking by folding and peeling by cutting of the recorded matter.

In an embodiment of the present disclosure, from the standpoint that cracking by folding and peeling by cutting of the recorded matter can be reduced, the content of the polyfunctional (meth)acrylate having a glycerol skeleton is preferably within a range of 30 parts by mass or more and 60 parts by mass or less relative to 100 parts by mass of the polymerizable compound.

In an embodiment of the present disclosure, from the standpoint that cracking by folding and peeling by cutting of the recorded matter can be reduced, the polyfunctional (meth)acrylate having a glycerol skeleton is preferably a propylene oxide-modified product.

In an embodiment of the present disclosure, from the standpoint that cracking by folding and peeling by cutting of the recorded matter can be reduced, the number of modifications of propylene oxide in the polyfunctional (meth)acrylate having a glycerol skeleton is preferably within a range of 3 or more and 9 or less. Furthermore, the number of modifications of propylene oxide in the polyfunctional (meth)acrylate having a glycerol skeleton is more preferably within a range of 3 or more and 4 or less.

In an embodiment of the present disclosure, from the viewpoint of image quality, the ratio Am/Wm of the mass Am of the polyfunctional (meth)acrylate having a glycerol skeleton to the mass Wm of the gelling agent is preferably in the range of 3.5 or more and 16 or less.

In an embodiment of the present disclosure, from the viewpoint of ink viscosity, the gelling agent preferably includes at least one of ketone-based wax, ester-based wax, glycerol-based wax, and pentaerythritol-based wax.

In an embodiment of the present disclosure, from the viewpoint of ink viscosity, it is preferable that the gelling agent has an alkyl group, and the carbon number of the alkyl group is 22 or less.

In an embodiment of the present disclosure, from the viewpoint of ink viscosity, the gelling agent preferably includes the ester-based wax.

In an embodiment of the present disclosure, the amount of water is preferably in a range of 0.5 to 1.0% by mass relative to the total mass of the ink from the viewpoint of ink viscosity.

In an embodiment of the present disclosure, the ink is preferably used in inkjet recording from the viewpoint of ink viscosity.

The inkjet recording method of an embodiment of the present disclosure is an inkjet recording method using the ink. The inkjet recording method of an embodiment of the present disclosure includes a step of after heating the ink to 50° C. or higher, ejecting the ink from an inkjet head to make the ink land on a recording medium.

The inkjet recording system of an embodiment of the present disclosure is an inkjet recording system using the ink. An inkjet recording system of an embodiment of the present disclosure includes an inkjet head that ejects the ink and an irradiation section (irradiator) that irradiates the ink landed on a recording medium with active rays.

Hereinafter, one or more embodiments of the present disclosure will be described with reference to the drawings. However, the scope of the present disclosure is not limited to the disclosed embodiments or illustrated examples. In the present description, “to” between two numerical values is used to indicate a range of values including the two numerical values as a lower limit value and an upper limit value.

### 1. Structure of Ink

The ink according to the present embodiment is an ink containing a polymerizable compound that is polymerized by active rays. The content of polyfunctional (meth)acrylate having a glycerol skeleton is 20 parts by mass or more relative to 100 parts by mass of the polymerizable compound. The ink contains a gelling agent.

### 1-1. Polymerizable Compound

In the present specification, the “polymerizable compound that is polymerized by active rays” is also simply referred to as the “polymerizable compound”. The ink according to the present embodiment contains a polymerizable compound. As a result, the ink of the present embodiment can be cured by being irradiated with active rays, and can make a coloring agent firmly adhere to a recording medium.

The ink according to the present embodiment contains a polyfunctional (meth)acrylate having a glycerol skeleton as a polymerizable compound. The ink of the present embodiment may further contain a polymerizable compound other than the polyfunctional (meth)acrylate having a glycerol skeleton. As the polymerizable compound, one kind thereof may be used alone, or two or more kinds thereof may be used in combination.

Specifically, the term “polymerizable compound” refers to a compound that is polymerized or crosslinked by irradiation with active rays. Examples of the active rays include electron beams, ultraviolet rays, alpha rays, gamma rays, and X rays. Among these, the active rays are preferably ultraviolet rays or electron beams, and more preferably ultraviolet rays.

### 1-1-1. Polyfunctional (Meth)Acrylate Having Glycerol Skeleton

The structural formula of glycerol is shown below.

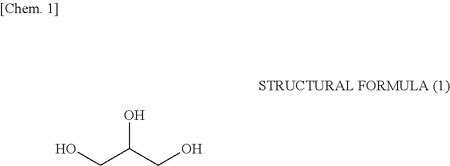

In the present embodiment, the “glycerol skeleton” refers to a moiety obtained by removing hydrogen atoms from the three hydroxy groups in the glycerol represented by the above structural formula (1). That is, the “polyfunctional (meth)acrylate having a glycerol skeleton” refers to a compound in which a hydrogen atom of a hydroxy group is replaced by another group and which has two or more (meth)acryloyl groups at the terminal.

In the present specification, the term “(meth)acrylate” is a generic term for “acrylate” and “methacrylate” and means one or both of them. The term “(meth)acryloyl group” is a generic term for “acryloyl group” and “methacryloyl group” and means one or both of them.

The polyfunctional acrylate having a glycerol skeleton may be a modified product by introducing a polyoxyalkylene group between the glycerol skeleton and the (meth)acryloyl group. In particular, the polyfunctional acrylate having a glycerol skeleton is preferably a propylene oxide-modified product. The number of modifications of propylene oxide is preferably in a range of 3 to 9, and more preferably in a range of 3 to 4.

By controlling the structure of the polyoxyalkylene group, the steric structure, the molecular weight, and the like of the polyfunctional acrylate having a glycerol skeleton can be controlled, and the hardness of the polymer, the viscosity of the ink, and the like can be controlled. As a result, it is possible to further reduce cracking by folding and peeling by cutting during processing of the recorded matter to be obtained. In addition, in a case of an inkjet ink, the viscosity can be adjusted to a viscosity at which favorable ejection characteristics are exhibited.

The polyfunctional (meth)acrylate having a glycerol skeleton is not particularly limited as long as it satisfies the definition described above. Examples of the polyfunctional (meth)acrylate having a glycerol skeleton include glycerin diacrylate, glycerin dimethacrylate, ethylene oxide-modified glycerin diacrylate, ethylene oxide-modified glycerin dimethacrylate, propylene oxide-modified glycerin diacrylate, propylene oxide-modified glycerin dimethacrylate, glycerin triacrylate, glycerin trimethacrylate, ethylene oxide-modified glycerin triacrylate, ethylene oxide-modified glycerin trimethacrylate, propylene oxide-modified glycerin triacrylate, propylene oxide-modified glycerin trimethacrylate, and the like.

The polyfunctional (meth)acrylate having a glycerol skeleton may be a compound in which three or more (meth)acryloyl groups are added to a polyglycerol skeleton. Examples of such a compound include ethylene oxide-modified diglycerin tetraacrylate, ethylene oxide-modified diglycerin tetramethacrylate, propylene oxide-modified diglycerin tetraacrylate, propylene oxide-modified diglycerin tetramethacrylate, ethylene oxide-modified tetraglycerin hexaacrylate, ethylene oxide-modified tetraglycerin hexamethacrylate, propylene oxide-modified tetraglycerin hexaacrylate, propylene oxide-modified tetraglycerin hexamethacrylate, and the like.

Examples of the polyfunctional acrylate having a glycerol skeleton are represented by the following structural formulae (2) to (5). The structural formulae (2) and (3) represent structures of bifunctional acrylate, the structural formula (4) represents a structure of trifunctional acrylate, and the structural formula (5) represents a structure of tetrafunctional acrylate. The structural formula (5) is a compound in which four acryloyl groups are added to a diglycerol skeleton. Note that in the present embodiment, the acryloyl groups in the following structural formulae (2) to (5) may be methacryloyl groups.

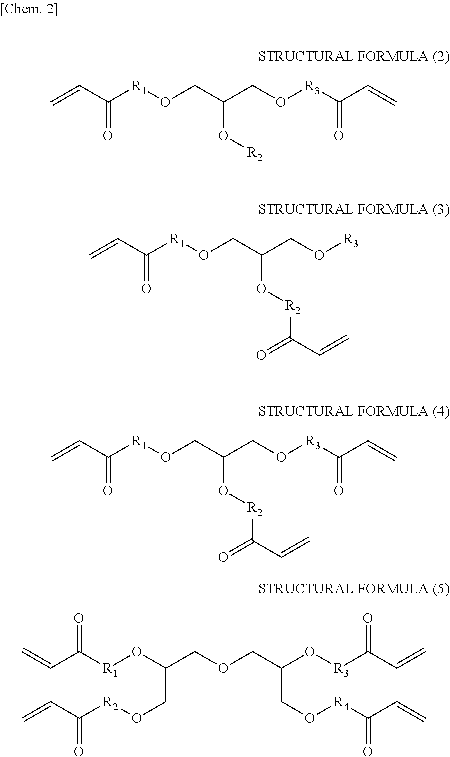

In the structural formulae (2) to (5), R₁, R₂, R₃ and R₄ each independently represent an alkylene group, a polyoxyalkylene group, or a hydrogen atom.

The alkylene group is not particularly limited, and examples thereof include a methylene group, an ethylene group, an n-propylene group, an isopropylene group, an n-butylene group, and an isobutylene group.

The polyoxyalkylene group is not particularly limited, and examples thereof include a structure represented by —(CH₂CH₂O)ₙ— and a structure represented by —(CH₂CH₂CH₂O)ₙ—. Note that n is an integer of 1 or more.

As a commercially available product of the polyfunctional (meth)acrylate having a glycerol skeleton, those having a degree of biomass of 35% or more approved by Japan Organic Resource Association are preferable. The “degree of biomass” refers to the content (dry weight ratio) of a biomass raw material contained in a product. Examples of the approved commercially available product include glycerin diacrylate “ARONIX® M-920” (ratio of plant raw material: 45%, manufactured by Toagosei Co., Ltd), glycerin triacrylate “ARONIX® M-930” (ratio of plant raw material: 37%, manufactured by Toagosei Co., Ltd), and the like.

The ratio of the plant raw material is expressed by the following Formula (1) based on the description of 26TREND2020 No. 23, Annual Report of Toagosei Co., Ltd.

Ratio of plant material [%]=(molecular weight of plant-derived material skeleton/total molecular weight)×100 Formula (1)

Examples of the commercially available product include propoxylated (3) glyceryl triacrylate “SR9020NS” (manufactured by Sartomer Co., Ltd), diglycerin EO-modified acrylate “ARONIX® M-460” (ratio of plant raw material: 30%, manufactured by Toagosei Co., Ltd), propoxylated (3.5) glyceryl triacrylate “EM2387” (manufactured by Choko Zairyo Kogyo Co., Ltd), and ethoxylated (3) glyceryl triacrylate “EM2388” (manufactured by Choko Zairyo Kogyo Co., Ltd).

The (meth)acrylate having a glycerol skeleton is preferably trifunctional rather than bifunctional. Thus, it is possible to further reduce cracking by folding and peeling by cutting during processing of the recorded matter to be obtained. Furthermore, as the (meth)acrylate having a glycerol skeleton, those having different numbers of functional groups may be used in combination.

In the ink of the present embodiment, the content of the polyfunctional (meth)acrylate having a glycerol skeleton is 20 parts by mass or more with respect to 100 parts by mass of the polymerizable compound. The content of the trifunctional (meth)acrylate having a glycerol skeleton is preferably 20 parts by mass or more with respect to 100 parts by mass of the polymerizable compound. Thus, it is possible to further reduce cracking by folding and peeling by cutting during processing of the recorded matter to be obtained.

It is preferable that the content of the polyfunctional (meth)acrylate having a glycerol skeleton is in the range of 30 parts by mass or more and 60 parts by mass or less relative to 100 parts by mass of the polymerizable compound. Thus, it is possible to further reduce cracking by folding and peeling by cutting during processing of the recorded matter to be obtained. In addition, in a case of an inkjet ink, the viscosity can be adjusted to a viscosity at which favorable ejection characteristics are exhibited.

In the ink according to the present embodiment, the ratio (Am/Wm) of the mass Am of the polyfunctional (meth)acrylate having a glycerol skeleton to the mass Wm of the gelling agent is preferably in the range of 3.5 or more and 16 or less. Thus, it is possible to further reduce cracking by folding and peeling by cutting during processing of the recorded matter to be obtained. In addition, in a case of an inkjet ink, the viscosity can be adjusted to a viscosity at which favorable ejection characteristics are exhibited.

Furthermore, the solubility parameter (HSP value) of the entire polymerizable compound is likely to be lowered by containing the polyfunctional (meth)acrylate having a glycerol skeleton. Thus, the compatibility between the polymerizable compound and the gelling agent is easily increased, that is, the solubility of the gelling agent is easily increased, and a large amount of the gelling agent is easily contained in the ink. As a result, the pinning properties of the ink can be improved. Also, from the viewpoint of the pinning properties of the ink, the mass ratio of the polyfunctional (meth)acrylate having a glycerol skeleton and the gelling agent is preferably within the above range.

### 1-1-2. Other Polymerizable Compound

Examples of the other polymerizable compounds mainly include a radically polymerizable compound and a cationically polymerizable compound. Among these, the polymerizable compound is preferably a radically polymerizable compound.

Examples of the radically polymerizable compound include unsaturated carboxylic acid esters and (meth)acrylates. Among these, the polymerizable compound is preferably (meth)acrylate. The (meth)acrylate may be monofunctional or polyfunctional.

Examples of the monofunctional (meth)acrylate include isoamyl acrylate, stearyl acrylate, lauryl acrylate, octyl acrylate, decyl acrylate, isomyristyl acrylate, isostearyl acrylate, 2-ethylhexyl-diglycol acrylate, butoxyethyl acrylate, phenoxyethyl acrylate, cumylphenoxyl ethyl acrylate, tetrahydrofurfuryl acrylate, isobornyl acrylate, 2-hydroxyethyl acrylate, 2-hydroxypropyl acrylate, 2-hydroxybutyl acrylate, t-butylcyclohexyl acrylate, and the like.

Examples of the bifunctional (meth)acrylate include 1,4-butanediol di(meth)acrylate, 1,6-hexanediol di(meth)acrylate, 1,9-nonanediol di(meth)acrylate, neopentyl glycol di(meth)acrylate, hydroxypivalic neopentyl glycol di(meth)acrylate, and polytetramethylene glycol di(meth)acrylate.

Examples of the trifunctional (meth)acrylate include trimethylolpropane tri(meth)acrylate, pentaerythritol tri(meth)acrylate, pentaerythritol tetra(meth)acrylate, dipentaerythritol hexa(meth)acrylate, and the like.

Examples of the cationically polymerizable compound include an epoxy compound and a vinyl ether compound.

Examples of the epoxy compound include 3,4-epoxycyclohexylmethyl-3′,4′-epoxycyclohexanecarboxylate, bis(3,4-epoxycyclohexylmethyl) adipate, E-caprolactone-modified 3,4-epoxycyclohexylmethyl 3′, 4′-epoxycyclohexanecarboxylate, 1-methyl-4-(2-methyloxiranyl)-7-oxabicyclo [4,1,0] heptane, 2-(3, 4-epoxycyclohexyl-5, 5-spiro-3, 4-epoxy) cyclohexanone-meta-dioxane, bis(2,3-epoxycyclopentyl) ether, 1,4-butanediol diglycidyl ether, 1,6-hexanediol diglycidyl ether, glycerin triglycidyl ether, and the like.

Examples of the vinyl ether compound include monovinyl ether compounds including ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-o-propylene carbonate, dodecyl vinyl ether, diethylene glycol monovinyl ether, octadecyl vinyl ether, and the like. Examples of the vinyl ether compound include di- or trivinyl ether compounds including ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, trimethylolpropane trivinyl ether, and the like.

The other polymerizable compound preferably includes a monofunctional polymerizable compound. The content of the monofunctional polymerizable compound is preferably 50 parts by mass or less with respect to 100 parts by mass of the polymerizable compound. In addition, the content of the polymerizable compound is preferably 40 parts by mass or less with respect to the total mass of the ink. When the content of the polymerizable compound is 5 parts by mass or more, the degree of crosslinking of the polymer is appropriately decreased, and the flexibility of the cured film can be further increased. As a result, cracking by folding of the recorded matter can be further reduced. When the content of the polymerizable compound is 50 parts by mass or less, the degree of crosslinking of the polymer does not excessively decrease. As a result, the degree of curing of the cured film can be further increased, and peeling by cutting can be further reduced.

The other polymerizable compound may include a polyfunctional polymerizable compound in addition to the monofunctional polymerizable compound. The inclusion of the polyfunctional polymerizable compound can further reduce peeling by cutting. The content mass ratio of the monofunctional polymerizable compound and the polyfunctional polymerizable compound is preferably in a range of 0 to 0.6 and more preferably in a range of 0.1 to 0.4. Here, the “content mass ratio of the monofunctional polymerizable compound and the polyfunctional polymerizable compound” is represented by “(mass of monofunctional polymerizable compound)/(mass of polyfunctional polymerizable compound)”. Note that the “mass of polyfunctional polymerizable compound” includes the mass of the polyfunctional acrylate having a glycerol skeleton.

It is preferable that the monofunctional polymerizable compound include a compound having a benzene ring in the molecule. By virtue of having a benzene ring in the molecule, a stack structure of benzene rings is formed by interaction (π-π interaction) between the benzene rings, and the hardness of the cured film is further increased. It is preferable to have one or two benzene rings in the molecule. Therefore, when the monofunctional polymerizable compound has a benzene ring in the molecule, cracking by folding of the recorded matter can be further reduced, and also peeling by cutting can be further reduced.

The compound having a benzene ring in the molecule may be modified by introducing a polyoxyalkylene group such as an ethylene oxide group or a propylene oxide group. In particular, the compound having a benzene ring in the molecule is preferably an ethylene oxide-modified product. As a result, the degree of crosslinking of the polymer is appropriately lowered, and the flexibility of the cured film can be further enhanced. The weighted average value (mass base) of the number of repetitions in the ethylene oxide group is preferably 2 or more, and more preferably 4 or more. From the viewpoint of easily forming a stack structure of benzene rings, the weighted average value (mass base) of the number of repetitions in the ethylene oxide group is preferably 8 or less.

When the cured film is stretched by folding or the like of the recorded matter, the stack of benzene rings are temporarily separated. Thus, the cured film is more likely to be stretched and the bent cured film is less likely to be broken, thereby further reducing cracking by folding of the recorded matter. In addition, since the temporarily separated benzene ring forms the stack structure again when the stretching is eliminated, the strength of the cured film is maintained. That is, it is considered that use of the ethylene oxide-modified product of the compound having a benzene ring in the molecule can reduce cracking by folding of the recorded matter without reducing the strength of the cured film.

The compound having a benzene ring in the molecule may be a radically polymerizable compound or a cationically polymerizable compound, but is preferably a radically polymerizable compound, and is preferably (meth)acrylate.

Examples of the monofunctional (meth)acrylate having a benzene ring in the molecule include phenoxyethyl acrylate, 2-hydroxy-3-phenoxypropyl acrylate, cumylphenoxylethyl acrylate, phenol acrylate, nonylphenol (meth)acrylate, and cresol (meth)acrylate. Examples of the monofunctional (meth)acrylate having a benzene ring in the molecule also include ethylene oxide-modified products and propylene oxide-modified products of the above.

The content of the compound having a benzene ring in the molecule is preferably 40 parts by mass or less, and more preferably within a range of 5 to 25 parts by mass, relative to 100 parts by mass of the polymerizable compound. By including the compound having a benzene ring in the molecule, it is possible to further increase the hardness of the cured film, and also it is possible to reduce peeling by cutting of the recorded matter. When the content of the compound having a benzene ring in the molecule is 40 parts by mass or less, the flexibility of the cured film is not excessively decreased, and cracking by folding of the recorded matter can be further reduced.

The content of the polymerizable compound having a melting point of 25° C. or higher is preferably 3 parts by mass or less relative to 100 parts by mass of the polymerizable compound. In the case of an inkjet ink, the content of the polymerizable compound having a melting point of 25° C. or higher is more preferably 1 part by mass or less, still more preferably 0.1 parts by mass or less, and particularly preferably 0% by mass, from the viewpoint of further improving ejection stability. That is, the polymerizable compound preferably has a melting point of lower than 25° C.

Examples of the polymerizable compound having a melting point of 25° C. or higher include octadecyl acrylate, tris (2-acryloyloxyethyl) isocyanurate, and behenyl acrylate.

Whether or not the melting point of the polymerizable compound is 25° C. or higher can be determined based on whether the polymerizable compound is in a liquid state or in a solid state at 25° C. That is, it can be determined by whether or not the polymerizable compound has fluidity at 25° C. The melting point of the polymerizable compound may be measured by a thermal analysis method such as differential scanning calorimetry (DSC) or differential thermal analysis (DTA).

The weight-average molecular weight (Mw) of the polymerizable compound is preferably in a range of 160 to 300, and more preferably in a range of 200 to 300. The weight-average molecular weight can be measured using gel permeation chromatography (GPC).

In the present embodiment, the “equivalent of the polymerizable group” or the like refers to an acryl equivalent weight in a case where the polymerizable compound is acrylate, for example. The “weighted average value of the equivalents of the polymerizable groups” refers to the total value of values each obtained by multiplying the equivalent of the polymerizable group of each polymerizable compound by the mass ratio of each polymerizable compound in the total amount of the entire polymerizable compound(s).

The weighted average value (mass base) of the equivalents of the polymerizable groups in the entire polymerizable compound is preferably in the range of 160 to 300 g/eq, more preferably in the range of 180 to 300 g/eq, and even more preferably in the range of 200 to 300 g/eq. When it is 160 g/eq or more, the degree of crosslinking of the polymer is appropriately decreased, and the flexibility of the cured film can be further increased. As a result, cracking by folding of the recorded matter can be further reduced. When it is 300 g/eq or less, the degree of crosslinking of the polymer does not excessively decrease. As a result, the hardness of the cured film can be further increased, and peeling by cutting can be further reduced.

The weighted average value (mass base) of the equivalents of the polymerizable groups is preferably in the range of 160 to 200 g/eq when the ink contains a yellow pigment as the coloring agent. The weighted average value (mass base) of the equivalents of the polymerizable groups is preferably in the range of 160 to 210 g/eq when the ink contains a black pigment as the coloring agent. The weighted average value (mass base) of the equivalents of the polymerizable groups is preferably in the range of 200 to 250 g/eq when the ink contains a red pigment as the coloring agent. The weighted average value (mass base) of the equivalents of the polymerizable groups is preferably in the range of 200 to 260 g/eq when the ink contains a blue pigment as the coloring agent.

The yellow pigment and the black pigment tend to absorb active rays. Therefore, when a yellow pigment or a black pigment is used, from the viewpoint of facilitating sufficient curing of the ink, the weighted average value is preferably set to be lower than that in the case of using another pigment such as a red pigment or a blue pigment.

The content of the polymerizable compound is not particularly limited, but is preferably in a range of 1 to 97% by mass with respect to the total mass of the ink. Furthermore, the content is more preferably in a range of 30 to 95% by mass, still more preferably in a range of 50 to 95% by mass, and particularly preferably in a range of 70 to 95% by mass.

### 1-2. Gelling Agent

By containing a gelling agent, the ink of the present embodiment undergoes a sol-gel phase transition before being irradiated with active rays. Specifically, when the ink is heated to, for example, 80° C., the gelling agent dissolves in the polymerizable compound contained in the ink and causes the ink to solate. When the temperature of the ink is set to around room temperature, for example, 35° C., the gelling agent crystallizes in the ink and causes the ink to gel. In the present specification, the compound capable of causing the ink to undergo a sol-gel phase transition is referred to as the “gelling agent”.

Around room temperature, the gelling agent crystallizes in the ink to be plate-like. At the time, it is preferable that a three dimensional space is formed by the gelling agent crystallized in a plate shape, and the polymerizable compound is included in this three dimensional space. Such a structure is hereinafter referred to as a “card house structure”. When the card house structure is formed, a liquid polymerizable compound is held in the space, and therefore, the gelation properties of the ink is further enhanced. Due to this, the dots formed by the ink landing on the recording medium are less likely to wet-spread, and the pinning properties of the ink are enhanced.

The ink of the present embodiment has a low viscosity at a high temperature and a high viscosity at a low temperature due to the sol-gel phase transition. Therefore, the ink tends to wet the recording medium at the time of landing, and cracking of the coating of the ink layer in the recorded matter to be formed can be suppressed. As a result, it is thought that peeling by cutting of the recorded matter can be reduced.

Examples of the gelling agent that readily forms the card house structure include ketone-based wax, ester-based wax, glycerol-based wax, pentaerythritol-based wax, petroleum-based wax, vegetable-based wax, animal-based wax, mineral-based wax, hydrogenated castor oil, modified wax, higher fatty acid, higher alcohol, hydroxystearic acid, fatty acid amide (N-substituted fatty acid amide and special fatty acid amide), higher amine, synthetic wax, dibenzylidene sorbitol, dimer acid, dimer diol, and the like.

Among these, from the viewpoint of further increasing the solubility in the polymerizable compound, the gelling agent is preferably ketone-based wax, ester-based wax, glycerol-based wax, or pentaerythritol-based wax. One kind of the gelling agent may be contained alone, or two or more kinds of the gelling agent may be used in combination.

Examples of the ketone-based wax include fatty acid ketones such as dibehenyl ketone, distearyl ketone, dieicosyl ketone, dipalmityl ketone, dilauryl ketone, dimyristyl ketone, myristyl palmityl ketone, and palmityl stearyl ketone.

Examples of the ester-based wax include fatty acid ester and sucrose fatty acid ester. Examples of the fatty acid ester include fatty acid esters of monoalcohols such as behenyl behenate, icosyl icosanoate, stearyl stearate, palmityl stearate, myristyl myristate, cetyl myristate, and oleyl palmitate. Examples of the aliphatic ester include fatty acid esters of polyhydric alcohols such as glycerin fatty acid ester, sorbitan fatty acid ester, propylene glycol fatty acid ester, ethylene glycol fatty acid ester, and polyoxyethylene fatty acid ester.

Examples of the glycerol-based wax include liquid fatty acid triglyceride having a carbon number in the range of 6 to 30. Examples of the liquid fatty acid triglyceride having a carbon number in the range of 6 to 30 include heptanoic acid or octanoic acid triglyceride. Examples of heptanoic acid or octanoic acid triglyceride include sunflower oil, corn oil, soybean oil, marrow oil, grapeseed oil, sesame seed oil, hazelnut oil, apricot oil, macadamia oil, allaria oil, castor oil, avocado oil, caprylic/capric acid triglyceride, jojoba oil, shea butter oil, and the like.

Examples of the pentaerythritol-based wax include pentaerythritol fatty acid ester. Examples thereof include pentaerythritol tetrastearate, and the like.

Examples of the higher fatty acid include behenic acid, arachidic acid, stearic acid, palmitic acid, myristic acid, lauric acid, oleic acid, and erucic acid.

Examples of the higher alcohol include stearyl alcohol and behenyl alcohol.

The gelling agent preferably has an alkyl group from the viewpoint of further enhancing the gelling property. In particular, the gelling agent is more preferably ketone-based wax represented by the following general formula (G1) or ester-based wax represented by the following general formula (G2), from the viewpoint of further enhancing the gelling property.

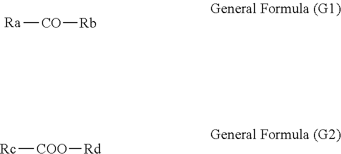

In General Formula (G1), Ra and Rb each independently represent a linear alkyl group having 12 to 22 carbon atoms. In General Formula (G2), Rc and Rd each independently represent a linear alkyl group having 12 to 22 carbon atoms.

In General Formula (G1) and General Formula (G2), when the carbon number of each of Ra to Rd is 12 or more, the crystallinity of the gelling agent represented by General Formula (G1) and General Formula (G2) is further enhanced, and a more sufficient space is generated in the formed card house structure. As a result, the polymerizable compound is more likely to be sufficiently contained in the space, and the gelation properties and the pinning properties of the ink are further improved.

In addition, when the carbon number of each of Ra to Rd is 22 or less, the melting point of the gelling agent represented by General Formula (G1) and General Formula (G2) is not excessively increased, and the solubility of the gelling agent is increased.

Examples of the ketone-based wax represented by General Formula (G1) include dibehenyl ketone (carbon number: 21-22), distearyl ketone (carbon number: 17-18), dieicosyl ketone (carbon number: 19-20), dipalmityl ketone (carbon number: 15-16), dimyristyl ketone (carbon number: 13-14), dilauryl ketone (carbon number: 11-12), lauryl myristyl ketone (carbon number: 11-14), lauryl palmityl ketone (11-16), myristyl palmityl ketone (13-16), myristyl stearyl ketone (13-18), myristylbehenyl ketone (13-22), palmityl stearyl ketone (15-18), valmityl behenyl ketone (15-22), stearyl behenyl ketone (17-22), and the like. The carbon numbers in the above parentheses represent the carbon numbers of two alkyl groups separated by a carbonyl group.

Examples of the ester-based wax represented by General Formula (G2) includes behenyl behenate (carbon number: 21-22), icosyl icosanoate (carbon number: 19-20), stearyl stearate (carbon number: 17-18), palmityl stearate (carbon number: 17-16), lauryl stearate (carbon number: 17-12), cetyl palmitate (carbon number: 15-16), stearyl palmitate (carbon number: 15-18), myristyl myristate (carbon number: 13-14), cetyl myristate (carbon number: 13-16), octyldodecyl myristate (carbon number: 13-20), stearyl oleate (carbon number: 17-18), stearyl erucate (carbon number: 21-18), stearyl linoleate (carbon number: 17-18), behenyl oleate (carbon number: 18 to 22), arachidyl linoleate (carbon number: 17-20), and the like. The carbon numbers in the above parentheses represents the carbon numbers of two alkyl groups separated by an ester group.

The content of the gelling agent is preferably in a range of 0.5% by mass to 10% by mass, and more preferably in a range of 1.5% by mass to 8% by mass, relative to the total mass of the ink. When the content is 0.5% by mass or more, the gelation properties and the pinning properties of the ink can be further enhanced. When the content is 10% by mass or less, the solubility of the gelling agent in the polymerizable compound can be further increased.

### 1-3. Others

The ink of the present embodiment may further contain other components, such as a coloring agent, a polymerization initiator, a polymerization inhibitor, and a surfactant, within a range where the effect of the present disclosure is exhibited.

### 1-3-1. Coloring Agent

The coloring agent is not particularly limited and may be a dye or a pigment, but is preferably a pigment because it has satisfactory dispersibility in constituent components of the ink and is excellent in weather resistance. The pigment is selectable in accordance with a color or the like of an image to be formed, from, for example, yellow pigment, red pigment, blue pigment, black pigment and white pigment.

Examples of the yellow pigment include Pigment Yellow (PY) 1, 3, 12, 13, 14, 17, 34, 35, 37, 55, 74, 81, 83, 93, 94, 95, and 97. Examples of the yellow pigment also include Pigment Yellow (PY) 108, 109, 110, 137, 138, 139, 153, 154, 155, 157, 166, 167, 168, 180, 185, and 193.

Examples of the red pigment include Pigment Red (PR) 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 202, 208, 216, 226, 257, Pigment Violet (PV) 3, 19, 23, 29, 30, 37, 50, 88, and Pigment Orange (PO) 13, 16, 20, and 36.

Examples of the blue pigment include Pigment Blue (PB) 1, 15, 15:1, 15:2, 15:3, 15:4, 15:6, 16, 17:1, 22, 27, 28, 29, 36, and 60.

Examples of the black pigment include C. I. Pigment Black 7, 26, and 28.

The white pigment may be any pigment that imparts a white color to a cured film formed by curing white ink. Examples of the white pigment include inorganic pigments such as titanium oxide, zinc oxide, calcium carbonate, barium sulfate, and aluminum hydroxide. Among these, the white pigment is preferably titanium oxide.

The crystal form of the titanium oxide may be any of a rutile type, an anatase type, or a brookite type. However, from the viewpoint of easily making the particle size small, the crystal form is preferably an anatase type having a small specific gravity. From the viewpoint of further enhancing the concealability of an image to be formed, the crystal form is preferably a rutile type having a large refractive index in the visible light region.

The content of the coloring agent is preferably in the range of 0.1 to 10% by mass, and more preferably in the range of 1 to 5% by mass, with respect to the total mass of the ink. In particular, the content of the white pigment is preferably within a range of 3 to 8% by mass.

### 1-3-2. Pigment Dispersant

When the coloring agent is a pigment, the ink may contain a pigment dispersant for dispersing the pigment. Examples of the pigment dispersant include hydroxy group-containing carboxylic acid ester, salt of long-chain polyaminoamide and high molecular weight acid ester, salt of high molecular weight polycarboxylic acid, salt of long-chain polyaminoamide and polar acid ester, high molecular weight unsaturated acid ester, polymeric copolymer, modified polyurethane, modified polyacrylate, polyether ester type anionic surfactant, naphthalenesulfonic acid formalin condensate salt, aromatic sulfonic acid formalin condensate salt, polyoxyethylene alkyl phosphate ester, polyoxyethylene nonylphenyl ether, stearylamine acetate, and the like.

The content of the pigment dispersant is preferably within a range of 10 to 200 parts by mass, and more preferably within a range of 20 to 100 parts by mass, relative to 100 parts by mass of the pigment. When the content of the pigment dispersant is 10 parts by mass or more relative to 100 parts by mass of the pigment, dispersion stability of the pigment is enhanced. When the content of the pigment dispersant is 200 parts by mass or less relative to 100 parts by mass of the pigment, ejection stability is enhanced in the case of an inkjet ink.

### 1-3-3. Polymerization Initiator

The ink may contain a polymerization initiator. The polymerization initiator may be any polymerization initiator as gar as it can initiate polymerization of the polymerizable compound upon irradiation with active rays. For example, when the ink contains a radically polymerizable compound, a radical polymerization initiator is used as the polymerization initiator. When the ink contains a cationically polymerizable compound, a cationic polymerization initiator (photoacid generator) is used as the polymerization initiator. Note that in a case where the ink can be sufficiently cured without a polymerization initiator, such as by irradiation with electron beams, the polymerization initiator is not required.

Examples of the radical polymerization initiator include an intramolecular bond cleavage type radical polymerization initiator and an intramolecular hydrogen abstraction type radical polymerization initiator.

Examples of the intramolecular bond cleavage type radical polymerization initiator include acetophenone-based initiators such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl-phenylketone, 2-methyl-2-morpholino (4-methylthiophenyl) propan-1-one, 2-benzyl-2-dimethylamino-1-(4-morpholinophenyl)-butanone. Examples of the intramolecular bond cleavage type radical polymerization initiator include benzoins such as benzoin, benzoin methyl ether, and benzoin isopropyl ether. Examples of the intramolecular bond cleavage type radical polymerization initiator include acylphosphine oxide-based initiators such as 2,4,6-trimethylbenzoin diphenyl phosphineoxide, and bis(2,4,6-trimethylbenzoyl)-phenylphosphineoxide. Examples of the intramolecular bond cleavage type radical polymerization initiator include benzyl glyoxyl ester and methylphenyl glyoxyl ester.

Examples of the intramolecular hydrogen abstraction type radical polymerization initiator include benzophenone-based initiators such as benzophenone, methyl o-benzoylbenzoate, 4-phenylbenzophenone, 4,4′-dichlorobenzophenone, hydroxybenzophenone, 4-benzoyl-4′-methyl-diphenyl sulfide, acrylated benzophenone, 3,3′,4,4′-tetra (t-butylperoxycarbonyl) benzophenone, and 3,3′-dimethyl-4-methoxybenzophenone. Examples of the intramolecular hydrogen abstraction type radical polymerization initiator include thioxanthone-based initiators such as 2-isopropylthioxanthone, 2,4-dimethylthioxanthone, 2,4-diethylthioxanthone, and 2,4-dichlorothioxanthone. Examples of the intramolecular hydrogen abstraction type radical polymerization initiator include aminobenzophenone-based initiators such as Michler's ketone, and 4,4′-diethylaminobenzophenone. Examples of the intramolecular hydrogen abstraction type radical polymerization initiator include 10-butyl-2-chloroacridone, 2-ethylanthraquinone, 9,10-phenanthrenequinone, and camphorquinone.

Examples of the cationic polymerization initiator include a photoacid generator. Examples of the photoacid generator include B(C₆F₅)₄⁻, PF₆⁻, AsF₆⁻, SbF₆⁻, and CF₃SO₃⁻ salts of aromatic onium compound. Examples of the aromatic onium compound herein include diazonium, ammonium, iodonium, sulfonium, phosphonium, and the like. Examples of the photoacid generator include a sulfonated product that generates sulfonic acid, a halide that photo-generates hydrogen halide, and an iron-allene complex.

The content of the polymerization initiator is not particularly limited as long as the ink is sufficiently cured by irradiation with active rays and the application of the ink onto the surface of a recording medium is not deteriorated. The content of the polymerization initiator is preferably in a range of 0.1 to 20% by mass and more preferably in a range of 1 to 10% by mass with respect to the total mass of the ink.

### 1-3-4. Polymerization Inhibitor

The ink may contain a polymerization inhibitor. By containing the polymerization inhibitor, it is possible to prevent monomers from polymerizing due to the influence of light, heat, air, or the like in the ink during storage.

Examples of the polymerization inhibitor includes (alkyl) phenol, hydroquinone, catechol, resorcin, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene) aniline oxide, dibutylcresol, cyclohexanone oxime cresol, guaiacol, o-isopropylphenol, butyraldoxime, methyl ethyl ketoxime, cyclohexanone oxime, and the like.

The content of the polymerization inhibitor is not particularly limited, but is preferably in the range of 0.05 to 10% by mass relative to the total mass of the ink.

### 1-3-5. Surfactant

The ink may contain a surfactant from the viewpoint of adjusting the surface tension.

Examples of the surfactant include anionic surfactants such as dialkylsulfosuccinates, alkylnaphthalenesulfonates, and fatty acid salts. Examples of the surfactant include nonionic surfactants such as polyoxyethylene alkyl ethers, polyoxyethylene alkyl allyl ethers, acetylene glycols, and polyoxyethylene or polyoxypropylene block copolymers. Examples of the surfactant include cationic surfactants such as alkylamine salts and quaternary ammonium salts. Examples of the surfactant include silicone-based surfactant and fluorine-based surfactant.

The content of the surfactant is not particularly limited, but is preferably in a range of 0.001 to 10% by mass and more preferably in a range of 0.001 to 1% by mass with respect to the total mass of the ink.

In the present embodiment, the ink may contain, if necessary, a fixing resin, a viscosity modifier, a specific resistance modifier, a film forming agent, an ultraviolet absorber, an antioxidant, an anti-fading agent, a fungicide, an antirust agent, and the like, in addition to the above-described components.

### 1-3-6. Water

The ink may contain water from the viewpoint of adjusting the viscosity, surface tension, and the like. The water is not particularly limited, and examples thereof include pure water such as ion-exchanged water, ultrafiltration water, reverse osmosis water, and distilled water. The water may be ultrapure water.

The content of the water (amount of water) is not particularly limited, but is preferably in a range of 0.5 to 1.0% by mass relative to the total mass of the ink.

### 2. Physical Properties of Ink

The viscosity of the ink at 60° C. is preferably in a range of 10 to 25 mPa·s and more preferably in a range of 10 to 15 mPa·s. Therefore, in the case of an inkjet ink, the stability at the time when the ink heated is ejected from a head can be enhanced. The viscosity of the ink at 60° C. can be adjusted by the type and the content of the polymerizable compound. The viscosity of the ink at 60° C. can be adjusted by the type and the content of the gelling agent.

The viscosity of the ink at 80° C. is preferably in a range of 6 to 25 mPa·s, and more preferably in a range of 7 to 15 mPa·s. Therefore, in the case of an inkjet ink, the stability at the time when the ink heated is ejected from a head can be enhanced. The viscosity of the ink at 80° C. can be adjusted by the type and the content of the polymerizable compound. The viscosity of the ink at 80° C. can be adjusted by the type and the content of the gelling agent.

The viscosity of the ink can be measured with a rheometer. For example, the ink is heated to 100° C., and is cooled to 20° C. under conditions of a shear rate of 11.7 (1/s) and a temperature lowering rate of 0.1° C./s while the viscosity is measured by a stress control rheometer, to obtain a temperature change curve of the viscosity. The viscosity at 60° C. or 80° C. is read from the obtained temperature change curve. Note that as the stress control rheometer, for example, “Physica MCR301” (cone plate diameter: 75 mm, cone angle: 1.0°, manufactured by AntonPaar Corporation) can be used.

### 3. Method for Preparing Ink

The ink according to the present embodiment can be prepared by mixing the polymerizable compound, the gelling agent, and any other components under heating. The obtained mixed liquid is preferably filtered through a predetermined filter. In addition, in a case of preparing an ink containing a pigment, it is preferable that first, a pigment dispersion liquid containing the pigment and a polymerizable compound is prepared, and then the pigment dispersion liquid and other components are mixed. The pigment dispersion liquid may further contain a dispersant.

The pigment dispersion liquid can be prepared by dispersing a pigment in a polymerizable compound. The pigment may be dispersed using, for example, a ball mill, a sand mill, an attritor, a roll mill, an agitator, a Henschel mixer, a colloid mill, an ultrasound homogenizer, a pearl mill, a wet jet mill, or a paint shaker. In the dispersion of the pigment, a dispersant may be added.

When multiple kinds of polymerizable compound are used, first, the polymerizable compounds may be mixed to prepare a polymerizable composition, and then the polymerizable composition, the gelling agent, and optional other components may be mixed under heating.

### 4. Inkjet Recording Method

In the recording method using the ink of the present embodiment, after the ink is applied to a recording medium, the ink is cured by irradiation with active rays. Thus, the coloring agent can be firmly adhered to the recording medium.

The method of applying the ink to the recording medium is not particularly limited. Examples of the method of applying the ink include spray coating, a dipping method, screen printing, gravure printing, offset printing, and an inkjet method.

Among these, the ink of the present embodiment is preferably applied using an inkjet method. A recorded matter can be produced easily and inexpensively by an inkjet method. Hereinafter, each step in the inkjet recording method will be described.

### 4-1. Step of Applying Ink to Recording Medium

In this step, the above-described ink is ejected from the inkjet head to apply the ink to a position on the surface of the recording medium corresponding to an image to be formed.

The ejection system from an inkjet head may be either an on-demand type or a continuous type. Examples of the on-demand type inkjet head include a single cavity type, a double cavity type, a bender type, and a piston type. Examples of the on-demand type inkjet head include an electro-mechanical conversion type such as a share mode type and a shared wall type. Examples of the on-demand type inkjet head include an electro-thermal conversion type such as a thermal inkjet type and a bubble Jet® type. The inkjet head may be either a scan type or a line type.

The ink is ejected from the inkjet head in a heated and solated state. Therefore, the temperature of the ink filled in the inkjet head is preferably set to be equal to or higher than the gelation temperature of the ink+10° C. and equal to or lower than the gelation temperature+30° C. When the temperature of the ink in the inkjet head is the gelation temperature+10° C. or more, gelation of the ink in the inkjet head or on the surface of the nozzles can be reduced, and decrease in the ejection characteristics can be reduced. When the temperature of the ink in the inkjet head is equal to or lower than the gelation temperature+30° C., it is possible to reduce the deterioration of the ink at a high temperature.

Specifically, it is preferable that the ink is heated to 50° C. or higher, then ejected from an inkjet head to land on a recording medium. The ink of the present embodiment can be set to the gelation temperature+10° C. or more by setting the temperature to 50° C. or more.

The method of heating the ink is not particularly limited. For example, at least one of an ink tank constituting the head carriage, an ink supply system (a supply pipe, a front chamber ink tank immediately before the head, and the like), a pipe with a filter, a piezo head, and the like is heated. Note that a panel heater, a ribbon heater, heat-retaining water, or the like can be used for heating.

The ejected droplet amount of the ink is preferably within a range of 2 to 20 pL from the viewpoint of further increasing the recording speed and the image quality.

The recording medium is not particularly limited in its type. Examples of the recording medium include ordinary non-coated paper, coated paper, synthetic paper Yupo®, and various plastics used for soft packaging. The various plastics may be films, and examples of the various plastic films include a polypropylene (PP) film, a polyethylene terephthalate (PET) film, and a biaxially stretched polystyrene sheet “OPS®”). Examples of the various plastic films include a biaxially stretched polypropylene (OPP) film, a biaxially stretched nylon (ONy) film, a polyvinyl chloride (PVC) film, a polyethylene (PE) film, and a triacetyl cellulose (TAC) film. Examples of other plastics include polycarbonate, (meth) acrylic resin, acrylonitrile-butadiene-styrene copolymer (ABS resin), polyacetal, polyvinyl alcohol (PVA), and rubbers.

The application of the ink to the recording medium may be performed by landing the ejected ink as it is on the recording medium. Alternatively, the ejected ink may be landed on an intermediate transfer member to form an intermediate image, and the intermediate image may be transferred and applied from the intermediate transfer member to a recording medium.

### 4-2. Step of Curing Ink

In this step, the droplets of the ink applied to the recording medium are irradiated with active rays to cure the droplets of the ink. Thus, an image (recorded matter) formed of a cured film of the ink is formed.

The active ray can be selected from, for example, an electron beam, an ultraviolet ray, an alpha ray, a gamma ray, and an X ray, and is preferably an ultraviolet ray or an electron beam. The ultraviolet rays are preferably light having a peak wavelength in the area of 360 to 410 nm. The ultraviolet rays are preferably applied from a light emitting diode (LED) light source. The LED emits less radiant heat than a conventional light source (e.g., a metal halide lamp). Therefore, at the time of irradiation with active rays, the LED causes the ink to be less likely to be dissolved, and causes gloss unevenness and the like to be unlikely to occur.

### 5. Inkjet Recording System

The inkjet recording system of the present embodiment uses the ink of the present embodiment. The inkjet recording system of the present embodiment includes an inkjet head that ejects ink, and an irradiation section that irradiates the ink landed on a recording medium with active rays. That is, the inkjet recording system of the present embodiment includes the ink of the present embodiment and an inkjet recording apparatus, and the inkjet recording apparatus includes an inkjet head and an irradiation section.

The FIGURE is a schematic diagram illustrating the configuration of an inkjet recording apparatus 100. As illustrated in the FIGURE, the inkjet recording apparatus 100 includes an inkjet head(s) 110, a conveyance section 120, and an irradiation section 130. Note that in the FIGURE, an arrow indicates a conveyance direction of a recording medium.

The inkjet head 110 has a nozzle(s) 111. The number of nozzles 111 may be equal to or greater than the number of inks used for image formation (for example, four). The nozzle 111 has an ejection port in the nozzle surface 113. The nozzle surface 113 faces the conveyance section 120 during recording (image formation) on the recording medium 200. The nozzle 111 ejects ink from the ejection port onto the recording medium 200 conveyed by the conveyance section 120.

The inkjet head 110 may include a device for adjusting the temperature of the ink. By adjusting the temperature of the ink, the viscosity of the ink can be lowered, and the ejection characteristics of the ink can be enhanced.

The inkjet head 110 may be a scan-type inkjet head in which the width in the direction orthogonal to the conveyance direction of the recording medium 200 is smaller than the recording medium 200. In addition, the inkjet head 110 may be a line type inkjet head in which the width in the direction orthogonal to the conveyance direction of the recording medium 200 is larger than the recording medium 200.

The conveyance section 120 conveys the recording medium 200 so that the recording medium 200 facing the inkjet head 110 moves during recording, immediately under the inkjet head 110 in the vertical direction. For example, the conveyance section 120 includes a drive roller 121, a driven roller 122, and a conveyance belt 123.

The irradiation section 130 irradiates the upper surface of the conveyance section 120 with active rays. Accordingly, it is possible, by irradiating the droplets of the ink landed on the recording medium 200 being conveyed with active rays, to cure the droplets. The irradiation section 130 is preferably positioned immediately above the conveyance section 120 on the downstream side of the inkjet head 110.

In addition to the above-described components, the inkjet recording apparatus 100 may include an ink tank (not illustrated) for storing the ink before ejection, an ink channel (not illustrated) that allows the ink tank and the inkjet head 110 to communicate with each other so that the ink can flow, and the like. In addition, the inkjet recording apparatus 100 may include a controller (not illustrated) which controls operations of the inkjet head 110, the conveyance section 120, and the irradiation section 130.

The inkjet recording apparatus 100 may include an intermediate transfer member and a transfer section (both not illustrated). The inkjet head 110 ejects ink to land the ink on the surface of the intermediate transfer member, and forms an intermediate image, which is a collection of ink droplets, on the surface of the intermediate transfer member. Thereafter, the transfer section transfers the intermediate image from the surface of the intermediate transfer member to the surface of the recording medium. The irradiation section 130 irradiates the intermediate image transferred onto the surface of the recording medium with active rays to cure the ink droplets.

### EXAMPLES

Hereinafter, the present disclosure will be specifically described with reference to Examples, but the present disclosure is not limited thereto. In Examples, “part(s)” or “%” means “parts by mass” or “% by mass” unless otherwise specified.

Furthermore, in the following Examples, unless otherwise specified, each procedure was performed at room temperature (25° C.).

### 1. Preparation and Synthesis of Materials

Materials used for preparing ink are listed below.

### 1-1. Polymerizable Compound [(Meth)Acrylate Having Glycerol Skeleton: Monomer 1]

The number of functional groups herein means the number of (meth)acryloyl groups.

M-930: glycerol triacrylate “M-930” (manufactured by Toagosei Co., Ltd, the number of functional group: 3)

M-460: diglycerin EO-modified acrylate “M-460” (manufactured by Toagosei Co., Ltd, number of functional groups: 4)

SR9020: propoxylated (3) glyceryl triacrylate “SR9020NS” (manufactured by Arkema Inc., number of functional groups: 3)

EM2387: propoxylated (3.5) glyceryl triacrylate “EM2387” (manufactured by Choko Zairyo Kogyo Co., Ltd, number of functional group: 3)

EM2388: ethoxylated (3) glyceryl triacrylate “EM2388” (manufactured by Choko Zairyo Kogyo Co., Ltd, number of functional groups: 3)

MX-1: ethoxylated (6) glyceryl triacrylate (number of functional groups: 3)

MX-2: propoxylated (12) glyceryl triacrylate (number of functional groups: 3)

MX-3: propoxylated (6) glyceryl triacrylate (number of functional groups: 3)

MX-4: propoxylated (9) glyceryl triacrylate (number of functional groups: 3)

Note that MX-1 to MX-4 were synthesized by known methods.

### [Other Monomer(s): Monomer 2]

M144: phenol 4EO modified acrylate “MIRAMER M144” (manufactured by MIWON Co., Ltd)

M164: nonylphenol 4EO modified acrylate “MIRAMER M164” (manufactured by MIWON Co., Ltd)

APG-200: tripropylene glycol diacrylate “APG-200” (manufactured by Shin-Nakamura Chemical Co., Ltd)

CN2270: polyester acrylate oligomer “CN2270NS” (manufactured by Arkema Inc)

A600: 14EO modified diacrylate “A-600” (manufactured by Shin-Nakamura Chemical Co., Ltd)

EM2382: 3EO modified trimethylolpropane triacrylate “EM2382” (manufactured by Choko Zairyo Kogyo Co., Ltd)

M360: 3PO modified trimethylolpropane triacrylate “MIRAMER M360” (manufactured by MIWON Co., Ltd)

EC: polyester acrylate “ETERCURE 6361-100” (manufactured by Choko Zairyo Kogyo Co., Ltd)

### 1-2. Pigment Dispersion Liquid

The following components were placed in a stainless steel beaker and heated and stirred for 1 hour while being heated to 65° C. on a hot plate.

Pigment dispersant “EFKA-7701” (manufactured by BASF Corporation) 9.0 parts by mass

Tripropylene glycol diacrylate 71.0 parts by mass

The mixed solution after stirring was cooled to room temperature, and in the stainless steel beaker after stirring, together with the following component and 200 g of zirconia beads (0.3 mm, manufactured by NIKKATO CORPORATION), placed in a glass bottle, and the glass bottle was sealed. Note that details of the pigment will be described later.

Pigment 20.0 parts by mass

The obtained pigment-containing liquid was subjected to dispersion treatment using a paint shaker, and then the zirconia beads were removed to obtain a pigment dispersion liquid. The dispersion treatment time was 4 hours when a cyan pigment or a black pigment were used, and 6 hours when a magenta pigment or a yellow pigment were used.

Details of the pigment are shown below.
Cyan pigment (C): Pigment Blue 15:4 “Chromaffin Blue 6332JC” (manufactured by Dainichiseika Color & Chemicals Mfg. Co., Ltd.)
Magenta pigment (M): Pigment Violet 19 and Red 202 mixed crystal “CINQUASIA MAGENTA RT-355D” (manufactured by BASF Corporation)
Yellow pigment (Y): Pigment Yellow 185 “D1155” (manufactured by BASF)
Black pigment (K): Pigment Black 7 “#52” (manufactured by Mitsubishi Chemical Corp.)

### 1-3. Gelling Agent

WEP3: behenyl behenate “WEP-3” (carbon number: 21-22, manufactured by Nof Corp.)

SS: stearyl stearate “EXCEPARL SS” (carbon number: 17-18, manufactured by Kao Corp.)

PTS: pentaerythritol tetrastearate (manufactured by Tokyo Chemical Industry Co., Ltd.)

The carbon number represents the carbon numbers of two alkyl groups separated by an ester group.

### 1-4. Polymerization Initiator

Polymerization initiator 1: bis(2,4,6-trimethylbenzoyl)-phenylphosphineoxide “Omnirad 819” (manufactured by IGM Resins B. V.)

Polymerization initiator 2: 2-isopropylthioxanthone “Speedcure 2-ITX” (manufactured by Arkema Inc)

### 1-5. Polymerization Inhibitor

Polymerization inhibitor: 4,4′-[(1,10-dioxo-1,10-decanediyl) bis(oxy)]bis [2,2,6,6-tetramethyl]-1-piperidinyloxy “Irgasutab UV-10” (manufactured by BASF)

### 1-6. Surfactant

Surfactant: polyether-modified silicone “KF-352A” (manufactured by Shin-Etsu Chemical Co., Ltd.)

### 2. Preparation of Ink

The pigment dispersion liquid, the polymerizable compound, the gelling agent, the polymerization initiator, the polymerization inhibitor, and the surfactant were put into a stainless steel beaker at the following ratio. These were stirred at 105° C. for 45 minutes. Thereafter, the stirred mixed liquid was filtered through a “Teflon®” 3 μm membrane filter (manufactured by ADVANTEC Co., Ltd) to obtain ink 1. The addition amounts were in terms of solid content.

| | |
|---|---|
| (Monomer 1) | |
| Propoxylated (3) glyceryl triacrylate “SR9020” | 23.6% by mass |
| (Monomer 2) | |
| Phenol 4EO modified acrylate “M144” | 12.2% by mass |
| Tripropylene glycol diacrylate “APG 200” | 20.2% by mass |
| 3EO modified trimethylolpropane triacrylate “EM2382” | 8.6% by mass |
| 3PO modified trimethylolpropane triacrylate “M360” | 14.2% by mass |
| Polyester acrylate “EC” | 10.9% by mass |
| (Pigment Dispersion Liquid) | |
| Black pigment | 2.0% by mass |
| Pigment dispersant | 0.9% by mass |
| (Gelling Agent) | |
| Behenyl behenate “WEP-3” | 1.5% by mass |
| Stearyl stearate “EXCEPARL SS” | 2.2% by mass |
| Polymerization initiator 1 | 3.0% by mass |
| Polymerization initiator 2 | 0.5% by mass |
| Polymerization inhibitor | 0.1% by mass |
| Surfactant | 0.1% by mass |

Each ink was prepared by the same procedure as in the preparation of the ink 1 except that the type and addition amount of the polymerizable compound, and the type and addition amount of the gelling agent were changed as listed in Tables I to IV.

### 3. Image Formation

For each ink, a single-color image was formed using a line-type inkjet recording apparatus. The temperature of the inkjet head of the inkjet recording apparatus was set to 80° C. A 5 cm×5 cm solid image was printed on a recording medium “OK TOP COAT+127 g” (manufactured by Oji Paper Co., Ltd.). Note that the temperature of the recording medium (paper base material) was 40° C. After the image was formed, an LED lamp (395 nm, water-cooled LED, manufactured by PhoseonTechnology Co., Ltd) disposed on the downstream portion of the recording apparatus irradiated the image with ultraviolet rays of 300 mJ/cm² to cure the ink.

In the image formation, a piezo head was used as a recording head for ejection. The ink was ejected from the recording head for ejection at a droplet amount of one droplet of 9.0 pL and a droplet speed of about 6 m/s, and recording was performed with 1200 dpi×1200 dpi resolution. The recording speed was set to 500 mm/s. The image formation was performed under an environment of 23° C. and 55% RH. Note that “dpi” represents the number of dots per inch (2.54 cm).

### 4. Evaluation

### 4-1. Cracking by Folding

The image formed on the recording medium was mountain-folded using a paper folder “AFV-564FKT” (manufactured by Horizon Corporation). Thereafter, the state of the image was observed, and the proportion of the area of a portion where exposure of the recording medium due to cracking did not occur (unexposed portion) was obtained by image analysis. Cracking by folding was evaluated according to the following criteria. Note that 3 or more (3 to 5) was determined to have no problem in practical use.
5: No image cracking was observed.
4: Cracking was observed in the image, but the exposure of the white background was slight.
3: Cracking was observed in the image, but the exposure of the white background was less than half of the area.
2: Cracking was observed in the image, and the white background was exposed in half or more of the area.
1: Cracking was observed in the image, and the white background was exposed in the entire area.

### 4-2. Peeling by Cutting (Abrasion Resistance of Image)

The image formation portion of the recording medium was cut using a bench cutter “PC-P430” (manufactured by Horizon Corporation). The cut part was rubbed with a finger, and the degree of peeling of the coating film (image) was evaluated according to the following criteria. Note that 3 or more (3 to 5) was determined to have no problem in practical use.
5: No peeling occurred in the coating film.
4: There was peeling, but it was not visually observed.
3: There was peeling, but it was hardly visually observed.
2: There was peeling, and it was visually observed.
1: There was large peeling, and it was clearly visually observed.

As to the score of 4, peeling was not visually observed, but when the coating film (image) was observed under an optical microscope at 100×, the length of peeling of the ink layer was 30 μm or less. As to the score of 3, the length of peeling of the ink layer was within a range of 31 to 100 μm under the same microscopic observation. When the length of peeling of the ink layer was more than 100 μm, it was visually observed.

### 4-3. Pinning Properties (Graininess)

The image was observed under a microscope (200×). The average value of the droplet diameters at 10 randomly selected positions was obtained, and the absolute value of the difference from a suitable droplet diameter (60 μm) was obtained. Note that 3 or more (3 to 4) was determined to have no problem in practical use.
4: The absolute value of the difference from the suitable droplet diameter was less than 3 μm.
3: The absolute value of the difference from the suitable droplet diameter was 3 μm or more and less than 5 μm.
2: The absolute value of the difference from the suitable droplet diameter was 5 μm or more and 7 μm or less.
1: The absolute value of the difference from the suitable droplet diameter was more than 7 μm.

The composition of each ink and the evaluation results are shown in Tables I to IV. With respect to the composition of each ink, only the kind and addition amount of the polymerizable compound, the kind and addition amount of the gelling agent, and the kind of the pigment, which were changed/different from those of the ink 1, are shown. The other components were the same as those of the ink 1. As to the pigment, K: represents a black pigment, C represents a cyan pigment, M represents a magenta pigment, and Y represents a yellow pigment. In each ink, the addition amount of the pigment was the same as that of the ink 1.

TABLE I

| | | EXAMPLE | EXAMPLE | EXAMPLE | EXAMPLE | EXAMPLE | EXAMPLE | EXAMPLE |
|---|---|---|---|---|---|---|---|---|
| | | 1 | 2 | 3 | 4 | 5 | 6 | 7 |
| INK NO. | | 1 | 2 | 3 | 4 | 5 | 6 | 7 |
| MONOMER 1 | SR9020 | 23.6 | 44.9 | 22.0 | 20.8 | 33.0 | 51.0 | — |
| [mass %] | M-930 | — | — | — | — | — | — | 21.0 |
| | M-460 | — | — | — | — | — | — | — |
| | EM2387 | — | — | — | — | — | — | — |
| | EM2388 | — | — | — | — | — | — | — |
| | MX-1 | — | — | — | — | — | — | — |
| | MX-2 | — | — | — | — | — | — | — |
| | MX-3 | — | — | — | — | — | — | — |
| | MX-4 | — | — | — | — | — | — | — |
| MONOMER 2 | M144 | 12.2 | — | 4.0 | 13.0 | 17.0 | 3.0 | 20.7 |
| [mass %] | M164 | — | — | 16.4 | 5.4 | — | 1.0 | 10.0 |
| | APG-200 | 20.2 | 23.8 | 20.1 | 24.3 | 21.7 | 16.1 | 13.0 |
| | CN2270 | — | — | — | 13.0 | — | 3.0 | — |
| | A600 | — | — | 9.0 | 4.5 | — | — | 20.0 |
| | EM2382 | 8.6 | — | — | 8.7 | — | — | 5.0 |
| | M360 | 14.2 | 16.1 | 16.6 | — | 9.8 | 8.0 | — |
| | EC | 10.8 | 4.9 | 1.6 | — | 8.2 | 7.6 | — |
| GELLING | WEP3 | 1.5 | 1.5 | 1.5 | 1.5 | 1.5 | 1.5 | 1.5 |
| AGENT | SS | 2.2 | 2.2 | 2.2 | 2.2 | 2.2 | 2.2 | 2.2 |
| [mass %] | PTS | — | — | — | — | — | — | — |

| | | | | | | | |
|---|---|---|---|---|---|---|---|
| WATER [mass %] | — | — | — | — | — | — | — |
| PIGMENT | K | K | C | M | Y | C | K |
| CRACKING BY FOLDING | 4 | 5 | 4 | 4 | 4 | 4 | 3 |
| PEELING BY CUTTING | 5 | 5 | 4 | 4 | 5 | 4 | 5 |
| PINNING PROPERTY | 4 | 4 | 4 | 4 | 4 | 4 | 4 |

TABLE II

| | | EXAMPLE | EXAMPLE | EXAMPLE | EXAMPLE | EXAMPLE | EXAMPLE | EXAMPLE |
|---|---|---|---|---|---|---|---|---|
| | | 8 | 9 | 10 | 11 | 12 | 13 | 14 |
| INK NO. | | 8 | 9 | 10 | 11 | 12 | 13 | 14 |
| MONOMER 1 | SR9020 | — | — | — | — | — | — | — |
| [mass %] | M-930 | — | — | — | — | — | — | — |
| | M-460 | 23.0 | — | — | — | — | — | — |
| | EM2387 | — | 25.0 | 42.2 | — | — | — | — |
| | EM2388 | — | — | — | 26.0 | — | — | — |
| | MX-1 | — | — | — | — | 22.0 | — | — |
| | MX-2 | — | — | — | — | — | 25.0 | — |
| | MX-3 | — | — | — | — | — | — | 26.0 |
| | MX-4 | — | — | — | — | — | — | — |
| MONOMER 2 | M144 | 18.5 | 10.2 | — | 3.2 | — | — | — |
| [mass %] | M164 | 17.2 | — | — | — | — | — | — |
| | APG-200 | 13.0 | 21.0 | 23.0 | 19.0 | 24.0 | 24.0 | 23.0 |
| | CN2270 | — | — | 1.5 | 8.0 | 12.5 | 18.9 | 11.8 |
| | A600 | 18.0 | — | — | — | — | — | 1.2 |
| | EM2382 | — | 6.5 | — | 5.0 | — | 8.8 | — |
| | M360 | — | 15.5 | 17.0 | 20.5 | 21.2 | — | 18.7 |
| | EC | — | 11.5 | 6.0 | 8.0 | 10.0 | 13.0 | 9.0 |
| GELLING | WEP3 | 1.5 | 1.5 | 1.5 | 1.5 | 1.5 | 1.5 | 1.5 |
| AGENT | SS | 2.2 | 2.2 | 2.2 | 2.2 | 2.2 | 2.2 | 2.2 |
| [mass %] | PTS | — | — | — | — | — | — | — |

| | | | | | | | |
|---|---|---|---|---|---|---|---|
| WATER [mass %] | — | — | — | — | — | — | — |
| PIGMENT | K | K | K | K | K | K | K |
| CRACKING BY FOLDING | 4 | 4 | 5 | 4 | 4 | 5 | 4 |
| PEELING BY CUTTING | 4 | 5 | 5 | 5 | 5 | 3 | 5 |
| PINNING PROPERTY | 4 | 4 | 4 | 4 | 4 | 4 | 4 |

TABLE III

| | | EXAMPLE | EXAMPLE | EXAMPLE | EXAMPLE | EXAMPLE | EXAMPLE | EXAMPLE |
|---|---|---|---|---|---|---|---|---|
| | | 15 | 16 | 17 | 18 | 19 | 20 | 21 |
| INK NO. | | 15 | 16 | 17 | 18 | 19 | 20 | 21 |
| MONOMER 1 | SR9020 | 44.9 | 22.5 | 20.5 | 38.0 | 25.9 | 24.1 | 21.0 |
| [mass %] | M-930 | — | — | — | — | — | — | — |
| | M-460 | — | — | — | — | — | — | — |
| | EM2387 | — | — | — | — | — | — | — |
| | EM2388 | — | — | — | — | — | — | — |
| | MX-1 | — | — | — | — | — | — | — |
| | MX-2 | — | — | — | — | — | — | — |
| | MX-3 | — | — | — | — | — | — | — |
| | MX-4 | — | — | — | — | — | 23.0 | — |
| MONOMER 2 | M144 | — | 4.5 | 4.5 | 6.0 | 16.0 | 3.0 | 3.0 |
| [mass %] | M164 | — | 16.9 | 16.9 | 5.0 | 4.0 | 1.0 | 16.1 |
| | APG-200 | 24.0 | 20.6 | 20.5 | 16.1 | 21.8 | 16.1 | 20.1 |
| | CN2270 | 0.5 | 0.5 | 0.5 | 6.0 | 3.0 | 5.0 | — |
| | A600 | — | 9.0 | 9.0 | — | — | — | 8.6 |
| | EM2382 | 0.7 | — | — | — | — | — | — |
| | M360 | 16.6 | 16.6 | 16.4 | 11.0 | 10.8 | 10.0 | 16.6 |
| | EC | 4.9 | 1.6 | 1.6 | 7.6 | 8.2 | 7.5 | 1.6 |
| GELLING | WEP3 | 0.7 | 0.5 | — | 1.5 | 1.5 | 1.5 | 2.3 |
| AGENT | SS | 1.1 | 0.7 | — | 2.2 | 2.2 | 2.2 | 4.1 |
| [mass %] | PTS | — | — | 3.5 | — | — | — | — |

| | | | | | | | |
|---|---|---|---|---|---|---|---|
| WATER [mass %] | — | — | — | — | — | — | — |
| PIGMENT | K | C | C | M | Y | C | C |
| CRACKING BY FOLDING | 5 | 4 | 4 | 4 | 4 | 4 | 4 |
| PEELING BY CUTTING | 5 | 4 | 4 | 4 | 5 | 4 | 4 |
| PINNING PROPERTY | 3 | 3 | 3 | 4 | 4 | 4 | 3 |

TABLE IV

| | | EXAMPLE | EXAMPLE | EXAMPLE | EXAMPLE | EXAMPLE | COMPARATIVE | COMPARATIVE |
|---|---|---|---|---|---|---|---|---|
| | | 22 | 23 | 24 | 25 | 26 | EXAMPLE 1 | EXAMPLE 2 |
| INK NO. | | 22 | 23 | 24 | 25 | 26 | 27 | 28 |
| MONOMER 1 | SR9020 | — | 50.7 | 50.4 | 23.5 | 65.0 | 15.0 | — |
| [mass %] | M-930 | — | — | — | — | 4.0 | — | — |
| | M-460 | — | — | — | — | — | — | — |
| | EM2387 | — | — | — | — | — | — | — |
| | EM2388 | — | — | — | — | — | — | — |
| | MX-1 | — | — | — | — | — | — | — |
| | MX-2 | 21.0 | — | — | — | — | — | — |
| | MX-3 | — | — | — | — | — | — | — |
| | MX-4 | — | — | — | — | — | — | — |
| MONOMER 2 | M144 | — | 3.0 | 3.0 | 12.1 | — | 5.0 | — |
| [mass %] | M164 | — | 1.0 | 1.0 | — | — | 5.0 | — |
| | APG-200 | 24.0 | 16.0 | 15.9 | 20.1 | 10.8 | 30.0 | 19.9 |
| | CN2270 | 18.9 | 3.0 | 3.0 | — | 0.5 | 13.2 | — |
| | A600 | — | — | — | — | — | — | 39.9 |
| | EM2382 | 5.2 | — | — | 8.5 | — | — | 29.9 |
| | M360 | 8.6 | 7.9 | 7.9 | 14.1 | 3.0 | 10.0 | — |
| | EC | 12.0 | 7.5 | 7.5 | 10.8 | 5.5 | 11.5 | — |
| GELLING | WEP3 | 1.5 | 1.5 | 1.5 | 1.5 | 1.9 | 1.5 | 1.5 |
| AGENT | SS | 2.2 | 2.2 | 2.2 | 2.2 | 2.7 | 2.2 | 2.2 |
| [mass %] | PTS | — | — | — | — | — | — | — |

| | | | | | | | |
|---|---|---|---|---|---|---|---|
| WATER [mass %] | — | 0.6 | 1.0 | 0.6 | — | — | — |
| PIGMENT | K | C | C | K | K | K | C |
| CRACKING BY FOLDING | 5 | 4 | 4 | 4 | 5 | 2 | 5 |
| PEELING BY CUTTING | 3 | 4 | 4 | 5 | 3 | 5 | 1 |
| PROPERTY | 4 | 4 | 4 | 4 | 4 | 4 | 3 |

In the polymerizable compound of each ink, the number of parts by mass of each monomer when the total amount of the monomers is 100 parts by mass is shown in Tables V to VIII. The “Total of Monomer 1” represents the total number of parts by mass of the monomer(s) 1 ((meth)acrylate having a glycerol skeleton). The “Total of Monomers 1 and 2” represents the total number of parts by mass of the monomer(s) 1 ((meth)acrylate having a glycerol skeleton) and the monomer(s) 2 (other monomers), that is, the total number of parts by mass of all the monomers, and is 100.0 parts by mass. The “Monomer 1/Gelling Agent” (Am/Wm) represents the ratio of the mass Am of the polyfunctional (meth)acrylate having a glycerol skeleton to the mass Wm of the gelling agent.

TABLE V

| | | EXAMPLE | EXAMPLE | EXAMPLE | EXAMPLE | EXAMPLE | EXAMPLE | EXAMPLE |
|---|---|---|---|---|---|---|---|---|
| | | 1 | 2 | 3 | 4 | 5 | 6 | 7 |
| INK NO. | | 1 | 2 | 3 | 4 | 5 | 6 | 7 |
| MONOMER 1 | SR9020 | 26.3 | 50.1 | 24.5 | 23.2 | 36.8 | 56.9 | — |
| [parts by | M-930 | — | — | — | — | — | — | 23.4 |
| mass] | M-480 | — | — | — | — | — | — | — |
| | EM2387 | — | — | — | — | — | — | — |
| | EM2388 | — | — | — | — | — | — | — |
| | MX-1 | — | — | — | — | — | — | — |
| | MX-2 | — | — | — | — | — | — | — |
| | MX-3 | — | — | — | — | — | — | — |
| | MX-4 | — | — | — | — | — | — | — |
| TOTAL OF | | 26.3 | 50.1 | 24.5 | 23.2 | 36.8 | 56.9 | 23.4 |
| MONOMER 1 | | | | | | | | |
| MONOMER | M144 | 13.6 | — | 4.5 | 14.5 | 19.0 | 3.3 | 23.1 |
| [parts by | M164 | — | — | 18.3 | 6.0 | — | 1.1 | 11.1 |
| mass] | APG-200 | 22.5 | 26.5 | 22.4 | 27.1 | 24.2 | 18.0 | 14.5 |
| | CN2270 | — | — | — | 14.5 | — | 3.3 | — |
| | A600 | — | — | 10.0 | 5.0 | — | — | 22.3 |
| | EM2382 | 9.6 | — | — | 9.7 | — | — | 5.6 |
| | M360 | 15.8 | 17.9 | 18.5 | — | 10.9 | 8.9 | — |
| | EC | 12.2 | 5.5 | 1.8 | — | 9.1 | 8.5 | — |

| | | | | | | | |
|---|---|---|---|---|---|---|---|
| TOTAL OF | 100.0 | 100.0 | 100.0 | 100.0 | 100.0 | 100.0 | 100.0 |
| MONOMERS 1 AND 2 | | | | | | | |
| MONOMER 1/ | 6.4 | 12.1 | 5.9 | 5.6 | 8.9 | 13.8 | 5.7 |
| GELLING AGENT | | | | | | | |
| Am/Wm | | | | | | | |

TABLE VI

| | | EXAMPLE | EXAMPLE | EXAMPLE | EXAMPLE | EXAMPLE | EXAMPLE | EXAMPLE |
|---|---|---|---|---|---|---|---|---|
| | | 8 | 9 | 10 | 11 | 12 | 13 | 14 |
| INK NO. | | 8 | 9 | 10 | 11 | 12 | 13 | 14 |
| MONOMER 1 | SR9020 | — | — | — | — | — | — | — |
| [parts by | M-830 | — | — | — | — | — | — | — |
| mass] | M-460 | 25.6 | — | — | — | — | — | — |
| | EM2387 | — | 27.9 | 47.0 | — | — | — | — |
| | EM2388 | — | — | — | 29.0 | — | — | — |
| | MX-1 | — | — | — | — | 24.5 | — | — |
| | MX-2 | — | — | — | — | — | 27.9 | — |
| | MX-3 | — | — | — | — | — | — | 29.0 |
| | MX-4 | — | — | — | — | — | — | — |
| TOTAL OF | | 25.6 | 27.9 | 47.0 | 29.0 | 24.5 | 27.9 | 29.0 |
| MONOMER 1 | | | | | | | | |
| MONOMER 2 | M144 | 20.6 | 11.4 | — | 3.6 | — | — | — |
| [parts by | M164 | 19.2 | — | — | — | — | — | — |
| mass] | APG-200 | 14.5 | 23.4 | 25.6 | 21.2 | 26.8 | 26.7 | 25.7 |
| | CN2270 | — | — | 1.7 | 8.8 | 13.9 | 21.1 | 13.2 |
| | A600 | 20.1 | — | — | — | — | — | 1.3 |
| | EM2382 | — | 7.2 | — | 5.6 | — | 9.8 | — |
| | M360 | — | 17.3 | 19.0 | 22.8 | 23.6 | — | 20.8 |
| | EC | — | 12.8 | 6.7 | 8.9 | 11.2 | 14.5 | 10.0 |

| | | | | | | | |
|---|---|---|---|---|---|---|---|
| TOTAL OF | 100.0 | 100.0 | 100.0 | 100.0 | 100.0 | 100.0 | 100.0 |
| MONOMERS 1 AND 2 | | | | | | | |
| MONOMER 1/ | 6.2 | 8.8 | 11.4 | 7.0 | 5.9 | 6.8 | 7.0 |
| GELLING AGENT | | | | | | | |
| Am/Wm | | | | | | | |

TABLE VII

| | | EXAMPLE | EXAMPLE | EXAMPLE | EXAMPLE | EXAMPLE | EXAMPLE | EXAMPLE |
|---|---|---|---|---|---|---|---|---|
| | | 15 | 16 | 17 | 18 | 19 | 20 | 21 |
| INK NO. | | 15 | 16 | 17 | 18 | 19 | 20 | 21 |
| MONOMER 1 | SR9020 | 49.1 | 24.5 | 22.8 | 42.3 | 29.0 | 27.0 | 24.2 |
| [parts by | M-930 | — | — | — | — | — | — | — |
| mass] | M-460 | — | — | — | — | — | — | — |
| | EM2387 | — | — | — | — | — | — | — |
| | EM2388 | — | — | — | — | — | — | — |
| | MX-1 | — | — | — | — | — | — | — |
| | MX-2 | — | — | — | — | — | — | — |
| | MX-3 | — | — | — | — | — | — | — |
| | MX-4 | — | — | — | — | — | 25.6 | — |
| TOTAL OF | | 49.1 | 24.5 | 22.8 | 42.3 | 29.0 | 52.6 | 24.2 |
| MONOMER 1 | | | | | | | | |
| MONOMER 2 | M144 | — | 4.9 | 5.0 | 6.7 | 17.8 | 3.3 | 3.4 |
| [parts by | M164 | — | 18.3 | 18.8 | 5.6 | 4.5 | 1.1 | 18.5 |
| mass] | APG-200 | 26.2 | 22.3 | 22.8 | 17.9 | 24.3 | 17.9 | 23.1 |
| | CN2270 | 0.5 | 0.5 | 0.6 | 6.7 | 3.3 | 5.6 | — |
| | A600 | — | 9.8 | 10.0 | — | — | — | 9.9 |
| | EM2382 | 0.8 | — | — | — | — | — | — |
| | M360 | 18.1 | 18.0 | 18.2 | 12.3 | 12.0 | 11.1 | 19.1 |
| | EC | 5.3 | 1.7 | 1.8 | 8.5 | 9.1 | 8.4 | 1.8 |

| | | | | | | | |
|---|---|---|---|---|---|---|---|
| TOTAL OF | 100.0 | 100.0 | 100.0 | 100.0 | 100.0 | 100.0 | 100.0 |
| MONOMERS 1 AND 2 | | | | | | | |
| MONOMER 1/ | 24.9 | 18.8 | 5.9 | 10.3 | 7.0 | 12.7 | 3.3 |
| GELLING AGENT | | | | | | | |
| Am/Wm | | | | | | | |

TABLE VIII

| | | EXAMPLE | EXAMPLE | EXAMPLE | EXAMPLE | EXAMPLE | COMPARATIVE | COMPARATIVE |
|---|---|---|---|---|---|---|---|---|
| | | 22 | 23 | 24 | 25 | 26 | EXAMPLE 1 | EXAMPLE 2 |
| INK NO. | | 22 | 23 | 24 | 25 | 26 | 27 | 28 |
| MONOMER 1 | SR9020 | — | 56.9 | 56.8 | 26.4 | 73.2 | 16.7 | — |
| [parts by | M-930 | — | — | — | — | 4.5 | — | — |
| mass] | M-460 | — | — | — | — | — | — | — |
| | EM2387 | — | — | — | — | — | — | — |
| | EM2388 | — | — | — | — | — | — | — |
| | MX-1 | — | — | — | — | — | — | — |
| | MX-2 | 23.4 | — | — | — | — | — | — |
| | MX-3 | — | — | — | — | — | — | — |
| | MX-4 | — | — | — | — | — | — | — |
| TOTAL OF | | 23.4 | 56.9 | 56.8 | 26.4 | 77.7 | 16.7 | — |
| MONOMER 1 | | | | | | | | |
| MONOMER 2 | M144 | — | 3.4 | 3.4 | 13.6 | — | 5.6 | — |
| [parts by | M164 | — | 1.1 | 1.1 | — | 12.2 | 5.6 | — |
| mass] | APG-200 | 26.7 | 18.0 | 17.9 | 22.6 | 0.5 | 33.5 | 22.2 |
| | CN2270 | 21.1 | 3.4 | 3.4 | — | — | 14.7 | — |
| | A600 | — | — | — | — | — | — | 44.5 |
| | EM2382 | 5.8 | — | — | 9.5 | 3.4 | — | 33.3 |
| | M360 | 9.6 | 8.9 | 8.9 | 15.8 | 6.2 | 11.1 | — |
| | EC | 13.4 | 8.4 | 8.5 | 12.1 | — | 12.8 | — |

| | | | | | | | |
|---|---|---|---|---|---|---|---|
| TOTAL OF | 100.0 | 100.0 | 100.0 | 100.0 | 100.0 | 100.0 | 100.0 |
| MONOMERS 1 AND 2 | | | | | | | |
| MONOMER 1/ | 5.7 | 13.7 | 13.6 | 6.4 | 15.0 | 4.1 | 0.0 |
| GELLING AGENT | | | | | | | |
| Am/Wm | | | | | | | |

It can be understood from Examples and Comparative Examples that the ink of the present disclosure can reduce cracking by folding and peeling by cutting in the recorded matter to be formed.

The following can be understood from Examples 1 to 7 and 9 to 25.

The content of the trifunctional (meth)acrylate having a glycerol skeleton is 20 parts by mass or more with respect to 100 parts by mass of the polymerizable compound. This can further reduce cracking by folding and peeling by cutting in the recorded matter to be formed.

The following can be understood from Examples 1 to 6.

The content of the polyfunctional (meth)acrylate having a glycerol skeleton is in a range of 30 parts by mass or more and 60 parts by mass or less relative to 100 parts by mass of the polymerizable compound. This can further reduce cracking by folding and peeling by cutting in the recorded matter to be formed.

The following can be understood from Examples 1, 7, 9, 11 to 14, and 22.

The polyfunctional (meth)acrylate having a glycerol skeleton is a propylene oxide-modified product. This can further reduce cracking by folding and peeling by cutting in the recorded matter to be formed. Further, the number of modifications being in the range of 3 or more and 9 or less, and particularly 3 or more and 4 or less, can further reduce cracking by folding and peeling by cutting.

The following can be understood from Examples.

The ratio Am/Wm of the mass Am of the polyfunctional (meth)acrylate having a glycerol skeleton to the mass Wm of the gelling agent is in a range of 3.5 or more and 16 or less. This can further reduce cracking by folding and peeling by cutting in the recorded matter to be formed.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An ink comprising:
a polymerizable compound that is polymerized by an active ray; and
a gelling agent,
wherein a content of polyfunctional (meth)acrylate having a glycerol skeleton is 20 parts by mass or more to 100 parts by mass of the polymerizable compound.

2. The ink according to claim 1, wherein the content of, as the polyfunctional (meth)acrylate, trifunctional (meth) acrylate having a glycerol skeleton is 20 parts by mass or more to 100 parts by mass of the polymerizable compound.

3. The ink according to claim 1, wherein the content of the polyfunctional (meth)acrylate having the glycerol skeleton is 30 parts by mass or more and 60 parts by mass or less to 100 parts by mass of the polymerizable compound.

4. The ink according to claim 1, wherein the polyfunctional (meth)acrylate having the glycerol skeleton is a propylene oxide-modified product.

5. The ink according to claim 4, wherein a number of modifications of propylene oxide in the polyfunctional (meth)acrylate having the glycerol skeleton as the propylene oxide-modified product is 3 or more and 9 or less.

6. The ink according to claim 5, wherein the number of modifications of propylene oxide in the polyfunctional (meth)acrylate having the glycerol skeleton as the propylene oxide-modified product is 3 or more and 4 or less.

7. The ink according to claim 1, wherein a ratio Am/Wm of a mass Am of the polyfunctional (meth)acrylate having the glycerol skeleton to a mass Wm of the gelling agent is 3.5 or more and 16 or less.

8. The ink according to claim 1, wherein the gelling agent includes at least one of a ketone-based wax, an ester-based wax, a glycerol-based wax, or a pentaerythritol-based wax.

9. The ink according to claim 1,
wherein the gelling agent has an alkyl group, and
wherein a carbon number of the alkyl group is 22 or less.

10. The ink according to claim 8, wherein the gelling agent includes the ester-based wax.

11. The ink according to claim 1, wherein an amount of water to a total mass of the ink is in a range of 0.5 to 1.0% by mass.

12. The ink according to claim 1, wherein the ink is used in inkjet recording.

13. An inkjet recording method using the ink according to claim 1, comprising:
heating the ink to 50° C. or more; and
ejecting the heated ink from an inkjet head to land the ink on a recording medium.

14. An inkjet recording system using the ink according to claim 1, comprising:
an inkjet head that ejects the ink; and
an irradiator that irradiates the ink landed on a recording medium with an active ray.
